(19) United States
(12) Patent Application Publication
(10) Pub. No.: US 2003/0151575 A1
(43) Pub. Date: Aug. 14, 2003

(54) Driver circuit for liquid crystal display panel

(75) Inventors: Shinya Udo, Kawasaki (JP); Masao Kumagai, Kawasaki (JP); Masatoshi Kokubun, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/283,658

(22) Filed: Oct. 30, 2002

(30) Foreign Application Priority Data
Feb. 14, 2002 (JP) 2002-36110

(51) Int. Cl. G09G 3/36

(52) U.S. Cl. 345/89

(57) ABSTRACT

A selector circuit, for selecting and outputting, in accordance with N-bit input data, one gray level reference voltage from 2^{N} gray level reference voltages, comprises: a plurality of select transistor arrays, which are provided in parallel between terminals of the gray level reference voltages and an output terminal and which have a plurality of serially connected transistors that are drive-controlled by the input data, wherein the select transistor arrays are each commonly provided for a group of M (M is a plurality and M<2^{N}) gray level reference voltages among the 2^{N} gray level reference voltages and are made to assume a drive enabled state by means of time division in correspondence with the M gray level reference voltages.

### BACKGROUND OF THE INVENTION

1. Field of the Invention

The present invention relates to a driver circuit for a liquid crystal display panel, and more particularly to a driver circuit in which the scale of a selector circuit thereof, which has a D/A conversion circuit for converting digital display data into analog drive voltages, is reduced.

2. Description of the Related Art

A liquid crystal display panel comprises a liquid crystal layer for the pixels and permits image gray levels to be displayed by applying drive voltages corresponding to pixel display data to the liquid crystal layer such that the light transmittance of the liquid crystal layer changes. When image display data is formed by eight bits, a display of 256 gray levels is possible, 256 types of drive voltage being accordingly applied to pixel electrodes that hold the liquid crystal layer therebetween.

FIG. 1 is a constitutional view of a typical liquid crystal display device. A display cell array 22 having a liquid crystal layer is provided in a display panel side, a circuit group for driving this display cell array 22 being connected to the display panel. The display cell array 22 has data bus lines DB1 to DBn, to which drive voltages corresponding to display data are applied, and scan bus lines SB1 to SBm which cross the data bus lines DB1 to DBn and are serially selected in synchronization with a horizontal synchronization signal Hsync, cell transistors and pixel electrodes (not shown) being provided at the points of intersection between these data bus lines and scan bus lines.

The scan bus lines SB are driven by a scan driver 24, and the data bus lines DB are driven by a data bus driver circuit group comprising: a shift register 10, a data latch circuit 12, a level shift circuit 14, a selector 18, and an output buffer 20. Cell transistors are selected by scan bus lines and data bus lines and pixel electrodes are connected, such that voltages applied to the data bus lines are transmitted to the pixel electrodes.

In the data bus driver circuit group, 8-bit display data D0 to D7 are serially latched by the data latch circuit 12. Latch timing signals are generated by the shift register 10 which shifts clock CLK. Digital display data latched by the data latch circuit 12 are level-shifted in the level shift circuit 14 from a digital power supply VDDD (3V, for example) to an analog power supply VDDA (12V, for example) and then supplied to the selector 18.

The selector 18 and the output buffer 20 correspond to a D/A conversion circuit. A voltage generating circuit 16 divides by resistors a reference voltage group VR0 to VR8 which is set in conformity with to a gamma curve or the like, generates 256 types of gray level reference voltage, namely Vr0 to Vr255, and supplies such voltages to the selector 18. The selector 18 selects any one of the 256 types of gray level reference voltage Vr0 to Vr255 in accordance with 8-bit digital display data latched by the data latch circuit 12, and supplies this gray level reference voltage to the output buffer 20. The output buffer 20 is a group of operational amplifiers, and same amplifies gray level reference voltages supplied from the selector 18 before applying such amplified voltages to the data bus lines DB. Tdiv is generated by a time divided control signal generator 26.

FIG. 2 is a constitutional view of a conventional selector. The voltage generating circuit 16 is a resistor ladder circuit in which a plurality of resistors is serially connected, gray level reference voltages Vr0 to Vr255 being generated from connecting nodes between the resistors. The gray level reference voltages Vr0 to Vr255 are supplied across the whole of the selector 18 via reference voltage lines which extend in a horizontal direction. Digital display data D0 to D7 are supplied to the selector via corresponding bus line. Further, as shown, the selector is constituted from 8-transistor arrays 30, 8-bit display data D0 to D7 being supplied to the transistor gate electrodes. Although not shown, more precisely, 8-bit signals, which are produced by pre-decoding the 8-bit display data D0 to D7, are supplied to the gate electrode of each of the transistors of the transistor arrays 30. Of 256 transistor arrays 30, eight transistors in one transistor array are all conductive, such that a selected gray level reference voltage Vr is supplied to an input terminal Opin of the operational amplifier 20. The gray level reference voltage Vr is supplied to the positive input side of the operational amplifier 20, the negative input thereof being connected to the operational amplifier output terminal OPout. An amplification operation with amplification factor 1 is thus performed to drive data bus lines DB.

As shown in the selector circuit in FIG. 2, 256 transistor arrays 30 are provided for one data bus line for the selection of any one of the 256 types of gray level reference voltage Vr0 to Vr255 in accordance with 8-bit display data D0 to D7. Accordingly, when there are a total of 384 data bus lines, 256×384 transistor arrays are then required. That is, 8×256×384=786432 transistors are required. Moreover, the three primary color components of RGB are necessary for a color display, which necessitates transistors in a quantity equal to three times that above. Further, although not shown in FIG. 2, data, which are produced by pre-decoding the 8-bit display data D0 to D7, are supplied to each transistor array, meaning that an inverter circuit for this pre-decoding is required for each transistor array.

A selector, which has such an enormous quantity of transistors therefore occupies the greater part of a data bus line driver circuit integrated circuit, which increases the scale of the integrated circuit and brings about increased costs.

### SUMMARY OF THE INVENTION

It is accordingly an object of the present invention to provide an integrated circuit in which the scale of a selector circuit thereof is reduced.

In order to resolve the above object, one aspect of the present invention is a selector circuit, for selecting and outputting, in accordance with N-bit input data, one gray level reference voltage from 2^{N} gray level reference voltages, comprising: a plurality of select transistor arrays, which are provided in parallel between terminals of the gray level reference voltages and an output terminal and which have a plurality of serially connected transistors that are drive-controlled by the input data, wherein the select transistor arrays are each commonly provided for a group of M (M is a plurality and M<2^{N}) gray level reference voltages among the 2^{N} gray level reference voltages and are made to assume a drive enabled state by means of time division in correspondence with the M gray level reference voltages.

If this is described using a specific example, each gray level reference voltage among the group of M (M=2, for example) gray level reference voltages is serially supplied by means of time division to the select transistor array, the select transistor array being made to assume a drive enabled state by means of time division in correspondence with the M gray level reference voltages. Gray level reference voltage, which is selected by means of input data, is outputted to the output terminal via the select transistor array which is made conductive by means of input data.

According to the above aspect of the invention, in the selector circuit, a select transistor array is provided for a group of M gray level reference voltages respectively, meaning that the quantity of select transistor arrays in the selector circuit can be reduced to 1/M. The scale of the selector circuit can therefore be reduced.

When the above selector circuit is utilized in a driver circuit of a liquid crystal display panel for converting digital display data into drive voltages, the scale of the driver circuit can be reduced as well as the cost of the driver circuit.

### BRIEF DESCRIPTION OF THE DRAWINGS

FIG. 1 is a constitutional view of a liquid crystal display device;

FIG. 2 is a circuit diagram of a conventional selector;

FIG. 3 is an outline constitutional view of a selector adopted in the present embodiment;

FIG. 4 is a concrete circuit diagram of the selector according to the present embodiment;

FIG. 5 shows a detail circuit for the selector;

FIG. 6 is an operation logic table for the selector in FIG. 5;

FIG. 7 shows a detail circuit for the selector;

FIG. 8 is an operation logic table for the selector in FIG. 6;

FIG. 9 is a drive signal waveform diagram corresponding to the operation of the selector;

FIG. 10 is another drive signal waveform diagram corresponding to the operation of the selector;

FIG. 11 is a selector detail circuit diagram for the positive polarity side thereof, according to a second embodiment;

FIG. 12 is an operation logic table for FIG. 11;

FIG. 13 is a selector detail circuit diagram for the negative polarity side thereof, according to the second embodiment;

FIG. 14 is an operation logic table for FIG. 13;

FIG. 15 is a circuit diagram of a selector according to a third embodiment; and

FIG. 16 shows a drive waveform corresponding to the operation of FIG. 15.

### DESCRIPTION OF THE PREFERRED EMBODIMENTS

Embodiments of the present invention will be described hereinbelow, referring to the drawings. However, the scope of protection of the present invention is not limited to or by the embodiments hereinbelow, but rather covers the inventions appearing in the claims for the patent and any equivalents thereof.

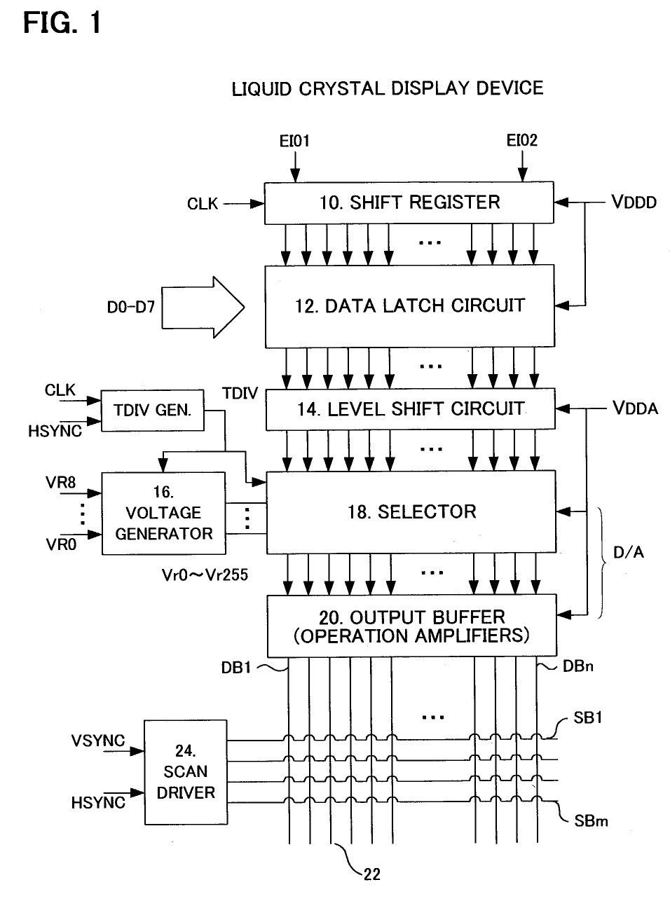

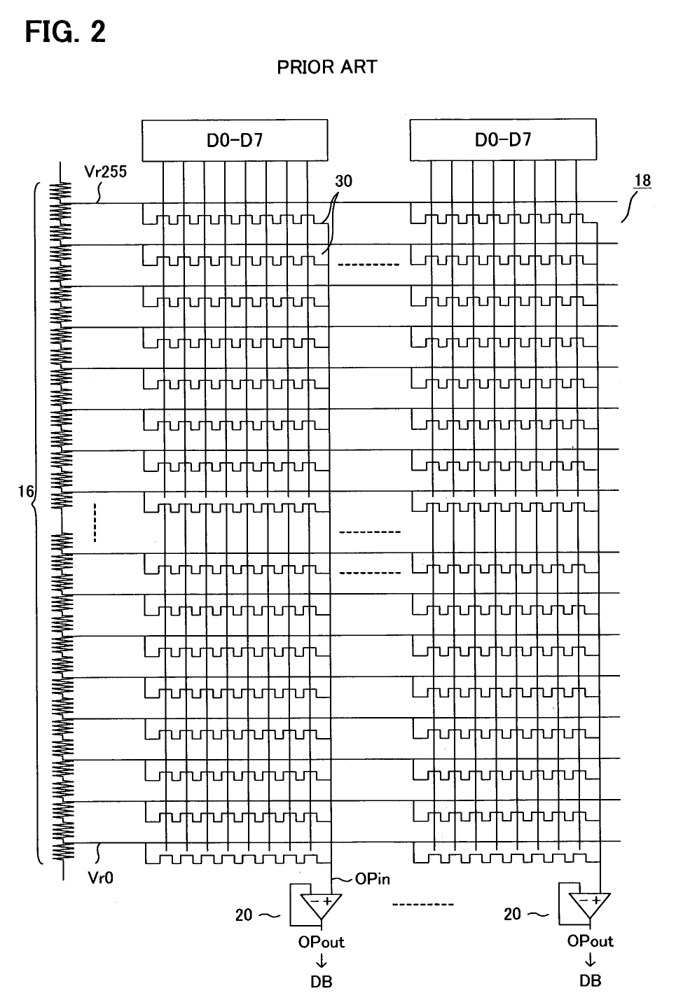

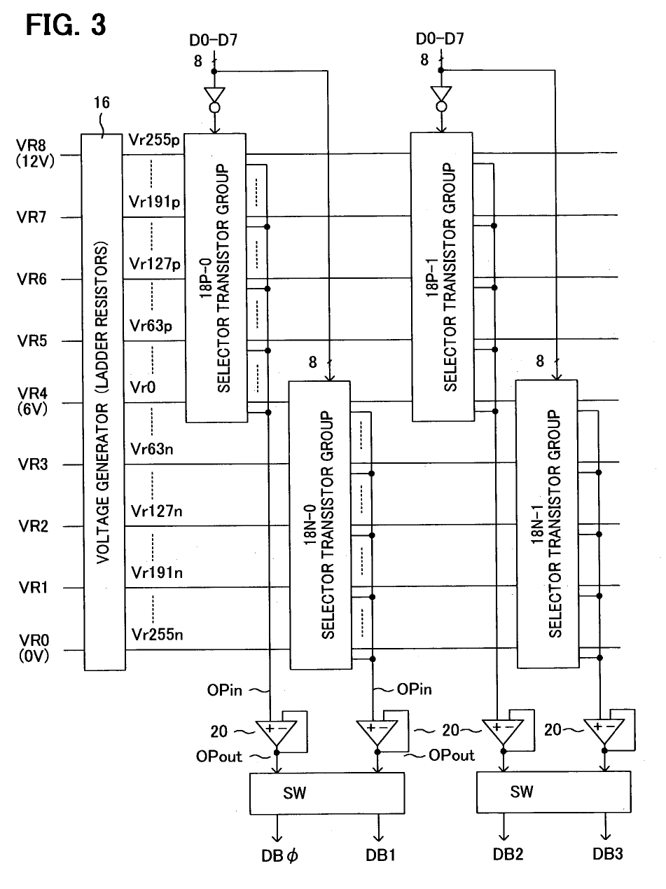

FIG. 1 is a constitutional view of a liquid crystal display device adopted in the present embodiment. The constitution in FIG. 1 is as already described. FIG. 3 is an outline constitutional view of the selector adopted in the present embodiment.

Reference voltages VR0 to VR8 are supplied to the voltage generating circuit 16. Of these reference voltages, a center level reference voltage VR4 is a common voltage. The voltage generating circuit 16 generates positive polarity side gray level reference voltages Vr0p to Vr255p from reference voltages VR4 to VR7 that are equal to or above the common voltage VR4, and generates negative polarity side gray level reference voltages Vr0n to Vr255n from reference voltages VR0 to VR4 that are equal to or below the common voltage VR4. The selector 18 is constituted from selector transistor groups 18P-0, 18N-0, 18P-1, 18N-1 . . . , and each of these selector transistor groups selects one gray level reference voltage, in accordance with display data D0 to D7, from among 256 gray level reference voltages, and supplies the gray level reference voltage thus selected to an input terminal OPin of an operational amplifier 20. In other words, the output terminal of a selector transistor group is connected to an operational amplifier input terminal OPin.

In order to extend the lifespan of the liquid crystal layer, AC drive voltages are applied to the data bus lines DB. In order to produce AC drive voltages, gray level reference voltages Vr0p to Vr255p, which are selected by positive polarity side selector transistor groups 18P, and gray level reference voltages Vr0n to Vr255n, which are selected by negative polarity side selector transistor groups 18N, are alternately applied to adjacent data bus lines DB0, DB1, and DB2, DB3. Normally, in synchronization with a horizontal synchronization signal, gray level reference voltages of a positive polarity and a negative polarity are applied alternately to adjacent data bus lines. For this reason, switch circuits SW are provided between the outputs OPout of the operational amplifiers 20 and the data bus lines DB.

As described hereinafter, the positive polarity side selector transistor groups 18P comprise select transistor arrays in which P-channel transistors are serially connected. Further, inverted data of display data D0 to D7 are pre-decoded and supplied to each gate electrode in these select transistor arrays, and the select transistor arrays are conductive when all of the supplied data are of an L level. On the other hand, the negative polarity side selector transistor groups 18N comprise select transistor arrays in which N-channel transistors are serially connected. Non-inverted data of the display data D0 to D7 are pre-decoded and supplied to each gate electrode of these select transistor arrays, and the select transistor arrays are conductive when all of the supplied data are of an H level.

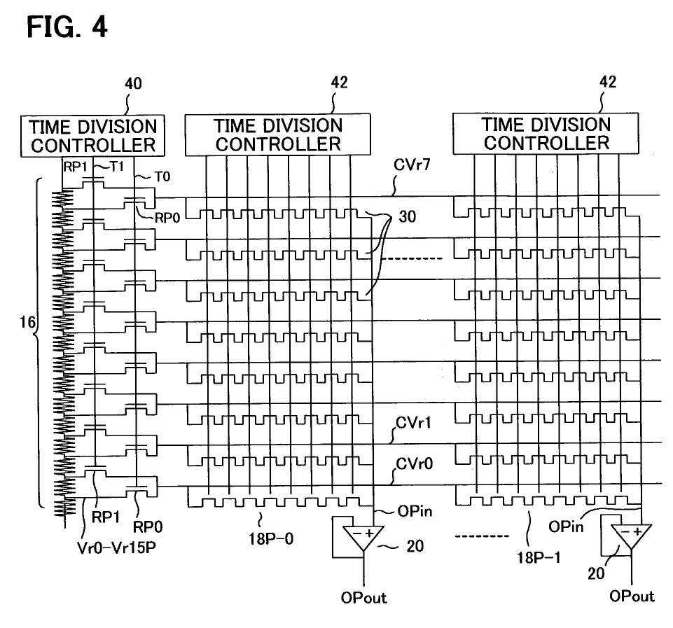

FIG. 4 is a concrete circuit diagram of the selector according to the present embodiment. The positive polarity side selector transistor groups 18P-0, 18P-1 in FIG. 3 are shown in this selector circuit, and, in order to simplify the circuit diagram, sixteen gray level reference voltages Vr0 to Vr15p, which are gray level reference voltages generated by the voltage generating circuit 16, are shown.

In these selector transistor groups, an 8-select transistor array 30 is provided for every two gray level reference voltages. That is, eight select transistor arrays 30 are provided for sixteen gray level reference voltages. Gray level reference voltage supply transistors RP0, RP1, which constitute a gray level voltage supply circuit, are provided between the select transistor arrays 30 and terminals of the gray level reference voltages Vr0 to Vr15p of the reference voltage generating circuit 16. In other words, the terminals of the gray level reference voltage Vr0 to Vr15p are connected in pairs to common reference voltage lines CVr0 to CVr7 via the gray level reference voltage supply transistors RP0, RP1, and the select transistor arrays 30 are provided in parallel between the common reference voltage lines CVr0 to CVr7 and an operational amplifier input terminal OPin.

Two gray level reference voltages of the gray level reference voltage terminals Vr0 to Vr15p are supplied by means of time division to the common reference voltage lines CVr0 to CVr7 respectively. In other words, in response to a time division signal T0, which is outputted from a time division control circuit 40, gray level reference voltage supply transistors RP0 are conductive such that a lower even gray level reference voltage of a group of two adjacent gray level reference voltages is supplied to a common reference voltage line. At such time, the select transistor arrays 30 assume a drive enabled state, and, in accordance with inputted display data, all the transistors of one select transistor array of eight select transistor arrays 30 are then conductive, such that the even gray level reference voltage supplied to the common reference voltage line is supplied to the operational amplifier input OPin. This even gray level reference voltage is held by a voltage holding circuit (not shown) which is provided at the operational amplifier input. Thereafter, in response to a time division signal T1, which is outputted from the time division control circuit 40, the gray level reference voltage supply transistors RP1 are-conductive (the transistors RP0 are then non-conductive), and a higher odd gray level reference voltage of two adjacent gray level reference voltages is supplied to a common reference voltage line. At such time, if the display data D0 to D7 are of an odd number, the conductive select transistor array 30 remains conductive, and the higher odd gray level reference voltage supplied to the common reference voltage line is supplied to the input OPin of the operational amplifier 20. On the other hand, if the display data D0 to D7 are of an even number, all of the select transistor arrays are controlled by a time division control circuit 42 so as to be non-conductive, such that the operational amplifier input OPin is maintained, by the voltage holding circuit, at the level of the even gray level reference voltage.

Therefore, the select transistor arrays 30 of the selector transistor groups are provided commonly to two gray level reference voltages respectively and are driven by means of time division, and, as a result of twice drive control of the select transistor arrays a gray level reference voltage, which is selected according to display data, is output to the operational amplifier. In other words, the drive operation of the select transistor arrays 30 is executed twice in one horizontal synchronization period by means of time division. Consequently, the quantity of select transistor arrays 30 is then halved in comparison with a conventional example. Moreover, the output voltage to the operational amplifier resulting from the first drive operation is equal to the gray level reference voltage which is ultimately selected, or is a voltage that is one gray level below this voltage. Consequently, the difference in the voltage for driving in the second drive operation is zero or is only one gray level, whereby it is possible to make the second drive operation time short.

When a margin exists in the horizontal synchronization period, the select transistor arrays 30 can be provided commonly to a plurality of gray level reference voltages greater than two, whereby a further reduction in the quantity of select transistor arrays 30 is also possible. For example, when the select transistor arrays are provided commonly to four gray level reference voltages, the quantity of gray level reference voltage supply transistors is also four, these being made to conduct in sequence, and the select transistor arrays 30 being subjected to drive operation four times.

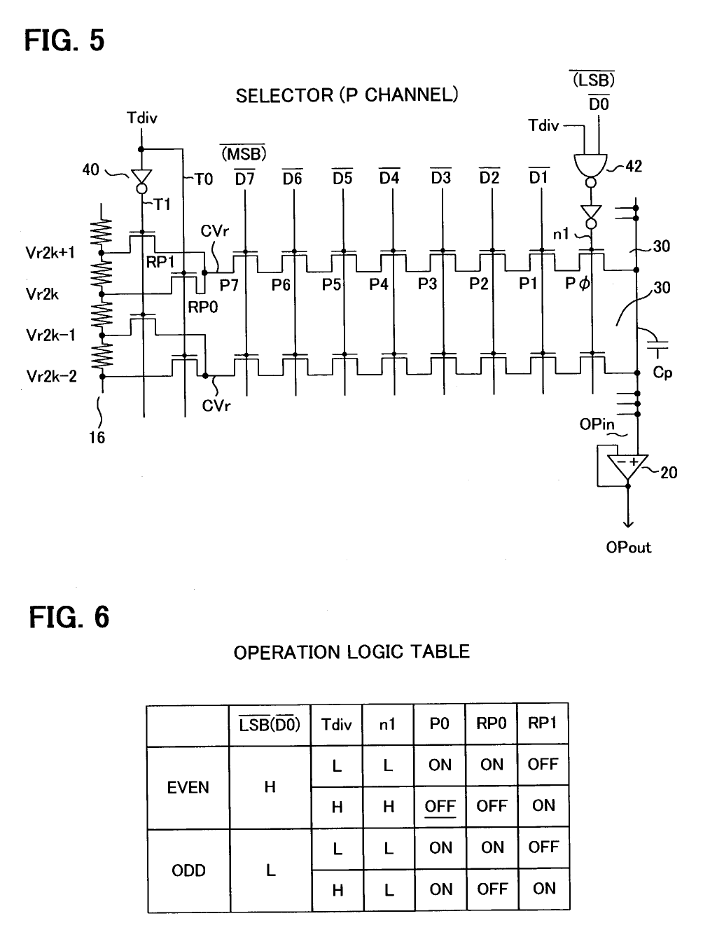

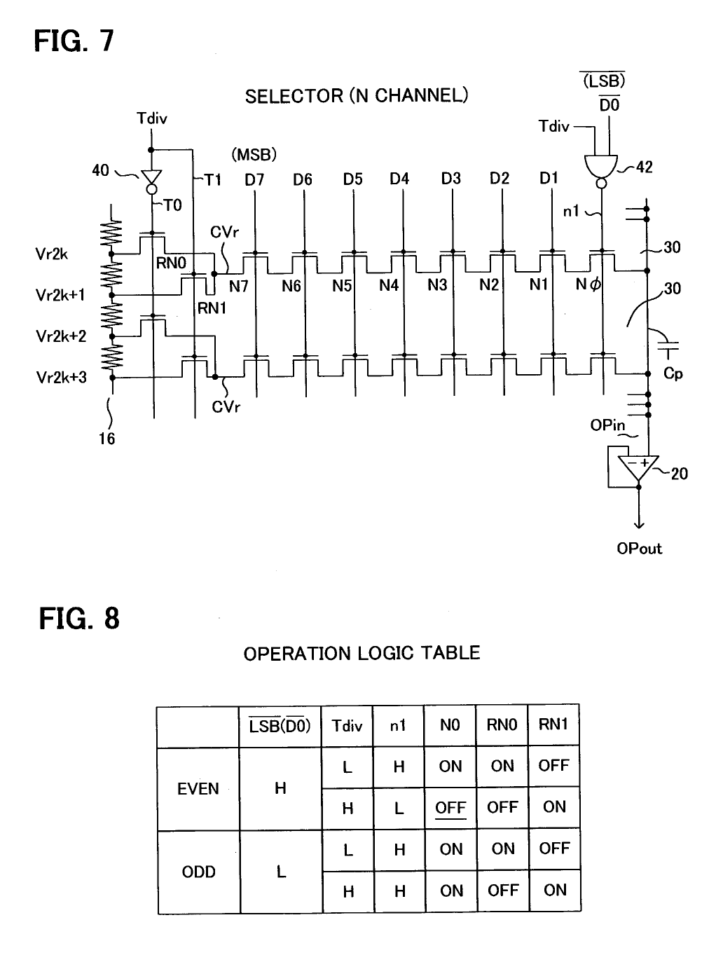

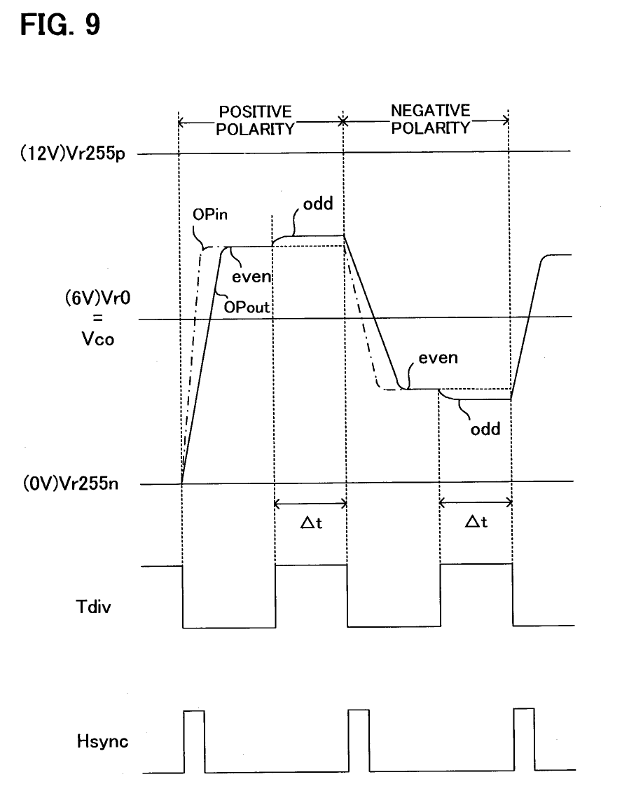

FIG. 5 shows a detail circuit for the selector, and FIG. 6 is an operation logic table for same. Further, FIGS. 7 and 8 are similarly a detail circuit diagram of the selector and an operation logic table for same, respectively. FIGS. 5 and 6 are for a transistor group formed by positive polarity side P-channel transistors, and FIGS. 7 and 8 are for a transistor group formed by negative polarity side N-channel transistors. Further, FIG. 9 is a drive signal waveform diagram corresponding to the operation of the selector.

The positive polarity side select transistor arrays 30 in FIG. 5 are constituted by serially connecting P-channel transistors P0 to P7. Further, inverted data of display data D1 to D7 are supplied to the gate electrode of the transistors P1 to P7 respectively. As described earlier, these display data D1 to D7 are data which are pre-decoded by inverters or the like (not shown), that is, data combinations of respectively different permutation are supplied to the 256 select transistor arrays 30.

In addition, an inverted signal of least significant bit display data D0 is supplied by a time division control circuit 42 to the gate of a drive control transistor P0, in accordance with the level of a division control signal Tdiv. The time division control circuit 42 is constituted from a NAND gate and an inverter, and the AND logical output for the least significant bit display data inverted signal /D0, and the division control signal Tdiv, is supplied to the gate of the drive control transistor P0. An output n1 of this time division control circuit 42 is supplied commonly to all the select transistor arrays 30 corresponding to the same data bus line, such that the select transistor arrays 30 are controlled to assume a drive enabled state or a drive disabled state.

When the drive control transistor P0 is in a conductive state, the select transistor array 30 assumes a drive enabled state, and, in accordance with the inputted display data D1 to D7, the select transistor array assumes a conductive state. When the drive control transistor P0 is in a non-conductive state, the select transistor array 30 assumes a drive disabled state.

Further, of the gray level reference voltages Vr generated by the voltage generating circuit 16, the even gray level reference voltage Vr2k is supplied to the common reference voltage line CVr and the select transistor array 30 via a gray level reference voltage supply transistor RP0. Further, an odd gray level reference voltage Vr2k+1 is supplied to the common reference voltage line CVr and the select transistor array 30 via the gray level reference voltage supply transistor RP1. Also, the gray level reference voltage supply transistors RP0, RP1 are made conductive in sequence in accordance with the control signals T0, T1 supplied from the time division control circuit 40.

The operation of the circuit in FIG. 5 will be explained with reference to the operation logic table of FIG. 6 and to the positive polarity of the drive signal waveform of FIG. 9. In synchronization with the horizontal synchronization signal Hsync, the time division control signal Tdiv is controlled to an L level in the first half of one horizontal synchronization period and controlled to an H level in the latter half thereof. Accordingly, the gray level reference voltage supply transistor RP0 is then conductive, such that the even gray level reference voltages Vr2k, Vr2K−2 are applied to the common reference voltage lines CVr.

Meanwhile, in the first half of the horizontal synchronization period, the time division control signal Tdiv assumes an L level, meaning that, at the division control circuit 42, regardless of whether the inversion level of the least significant bit D0 of the display data is of an H level or an L level, the output node n1 is compulsorily set to an L level. Consequently, the drive control transistors P0 all assume a conductive state such that the select transistor arrays assume a drive enabled state. Further, of the select transistor arrays 30, the transistors P1 to P7, to which higher order bit display data D1 to D7 are supplied, are all conductive when these display data are all of an L level. Therefore, either an even gray level reference level, which is the same as a gray level reference voltage to be selected, or an even gray level reference level which is one gray level below the gray level reference voltage to be selected, is supplied to the operational amplifier input OPin.

As indicated by the alternate long and short dash line in FIG. 9, the operational amplifier input OPin is driven on a positive polarity side, and with a given time lag, the operational amplifier output OPout is also driven on the positive polarity side. In accordance with this state, the operational amplifier input and output are both driven at an even gray level reference voltage “even”. A plurality of select transistor arrays are connected to an operational amplifier input terminal so that the input terminal has a parasitic capacitor Cp of a given magnitude, and therefore the reference voltage of the operational amplifier input Opin is stored in the parasitic capacitor Cp. In other words, this parasitic capacitor Cp and the operational amplifier are a voltage holding circuit.

Next, in the latter half of the horizontal synchronization period, the time division control signal Tdiv is controlled to an H level. Accordingly, the gray level reference voltage supply transistors RP0 and RP1 are made non-conductive and conductive respectively, and the odd gray level reference voltages Vr2k+1, Vr2K−1 are supplied to the common reference voltage lines CVr. At this point, if display data D0 to D7 are of an even number, inverted data of the least significant bit D0 is of an H level, the output n1 of the time division control circuit 42 is an H level, and the drive control transistor P0 assumes a non-conductive state. Further, if display data D0 to D7 are of an odd number, the inverted data of the least significant bit D0 is of an L level, the output n1 of the time division control circuit 42 is an L level, and the conductive state of the drive control transistor P0 is maintained.

Accordingly, when the display data are of an odd number, the conductive state of the select transistor array 30 is maintained, and the odd gray level reference voltage Vr2k+1 supplied to the common reference voltage line CVr is supplied to the operational amplifier input OPin. Therefore, as shown in FIG. 9, the operational amplifier input OPin and output OPout rise from the even gray level reference voltage “even” to the odd gray level reference voltage “odd”. On the other hand, when the display data are of an even number, the drive control transistor P0 is compulsorily made non-conductive, the select transistor array 30 is then non-conductive, and the even gray level reference voltage “even” supplied in the first half [of the horizontal synchronization period is maintained at the operational amplifier input and output; that is, as indicated by the broken line in FIG. 9.

The timing for the switching of the time division control signal Tdiv is set such that a time interval Δt, as necessitated by a time interval required for the application of a drive voltage to the liquid crystal layer, or by a time interval required to change the light transmittance of the liquid crystal layer, or the like, can be included in the latter half of the horizontal synchronization period. Furthermore, this timing is preferably set as timing that permits switching of select transistor arrays within the selector 18 and that allows the operational ampligier input OPin to rise sufficiently while the time division control signal Tdiv is at an L level. The timing for the change to the time division control signal Tdiv is determined in order to satisfy these two demands.

The time division control signal Tdiv is generated by a time division control signal generating circuit 26, which is shown in FIG. 1. The horizontal synchronization signal Hsync and clocks CLK are supplied to this time division control signal generating circuit 26. At the time when the horizontal synchronization signal Hsync is supplied, the control signal Tdiv is controlled to an L level, and, at the time when a prescribed number of clocks CLK have been counted, the control signal Tdiv is controlled to an H level.

Next, a description will be provided for the negative polarity side selector transistor group in FIG. 7. The negative polarity side selector transistor group selects, in accordance with display data D0 to D7, any one of gray level reference voltages Vr0 to Vr255n which span a voltage range that is between 0V and 6V and divided into 256 levels, and supplies this gray level reference voltage to an operational amplifier input Opin. Since the output voltage is low, the select transistor arrays 30 are constituted from eight N-channel transistors N0 to N7. Higher order display data D1 to D7 are supplied to seven transistors N1 to N7, and a control signal n1 from a time division control circuit 42 is supplied to the lowest order drive control transistor N0.

The higher order display data D1 to D7 are supplied respectively to each select transistor array in pre-decoded, combined fashion. On the other hand, the output n1 of the time division control circuit 42 is supplied commonly to all the select transistor arrays. However, the time division control circuit 42 is of a polarity that is the opposite of that of the P-channel side (positive polarity side) control circuit 42 in FIG. 5.

Further, of the gray level reference voltages generated by the voltage generating circuit 16 (constituted from a resistor ladder circuit), two adjacent gray level reference voltages are alternately supplied to a common reference voltage line CVr via the gray level reference voltage supply transistors RN0, RN1. These gray level reference voltage supply transistors RN0, RN1 are controlled by control signals T0, T1 from the time division control circuit 40.

Selector operation on a negative polarity side will now be described with reference to the operation logic table in FIG. 8 and the negative polarity drive waveform in FIG. 9. In response to the horizontal synchronization signal Hsync, the time division control signal Tdiv is at an L level, such that the N-channel gray level reference voltage supply transistor RN0 conducts. The even gray level reference voltages Vr2k, Vr2K+2 are thus supplied to common reference voltage lines CVr.

Meanwhile, in accordance with the L level of the time division control signal Tdiv, the output n1 of the time division control circuit 42 compulsorily assumes an H level, such that the drive control transistor N0 is conductive and the select transistor array assumes a drive enabled state. Further, of the plurality of select transistor arrays 30, in a select transistor array for which supplied display data D1 to D7 are all of a H level, the transistors N1 to N7 are conductive. As a result, the even gray level reference voltage Vr2k or Vr2K+2 is supplied to the operational amplifier input OPin.

In the latter half of the horizontal synchronization period, the time division control signal Tdiv changes to an H level, the gray level reference voltage supply transistor RN0 is non-conductive, and the transistor RN1 is conductive. The odd gray level reference voltages Vr2k+1, Vr2K+3 are accordingly supplied to common reference voltage lines CVr. At such time, when display data are of an even number, inverted data of the least significant bit D0 assumes an H level and the output n1 of the time division control circuit 42 assumes an L level such that the drive control transistor N0 is then non-conductive. As a result, the voltage of the operational amplifier input OPin is maintained at the former even gray level reference voltage. On the other hand, when display data are of an odd number, the inverted data of the least significant bit D0 is of an L level and the output n1 of the time division control circuit 42 retains an H level such that the conductive state of the drive control transistor N0 is maintained. As a result, the select transistor array 30 maintains a conductive state, the odd gray level reference voltage Vr2k+1 or Vr2K+3 is supplied to the operational amplifier input OPin, and the operational amplifier output OPout likewise also changes.

As shown in FIG. 9, a negative polarity simply amounts to a drive waveform which is the reverse of that for a positive polarity, and, if display data are of an even number, the select transistor array is conductive for only the first half of the waveform such that an even gray level reference voltage “even” is outputted. Further, if the display data are of an odd number, the select transistor array is also conductive in the latter half of the waveform, which follows the first half of same, such that an odd gray level reference voltage “odd” is outputted.

The transistors P0 and N0 in the select transistor arrays 30 in FIGS. 5, 7 may also be in positions that are: the position of any of the transistors P1 to P7, and the position of any of the transistors N1 to N7, respectively.

As described hereinabove, the select transistor arrays of the selector according to the present embodiment are each provided so as to be common to two gray level reference voltages, which halves the quantity of these select transistor arrays. Further, in the first half of the horizontal synchronization period, a select transistor array selected with respect to display data is driven regardless of whether the display data are of an even or odd number, and, in the latter half of the horizontal synchronization period, is driven only when display data are of an odd number. In other words, the quantity of select transistor arrays is halved, same being accordingly driven twice, by means of time division, in correspondence with this quantity.

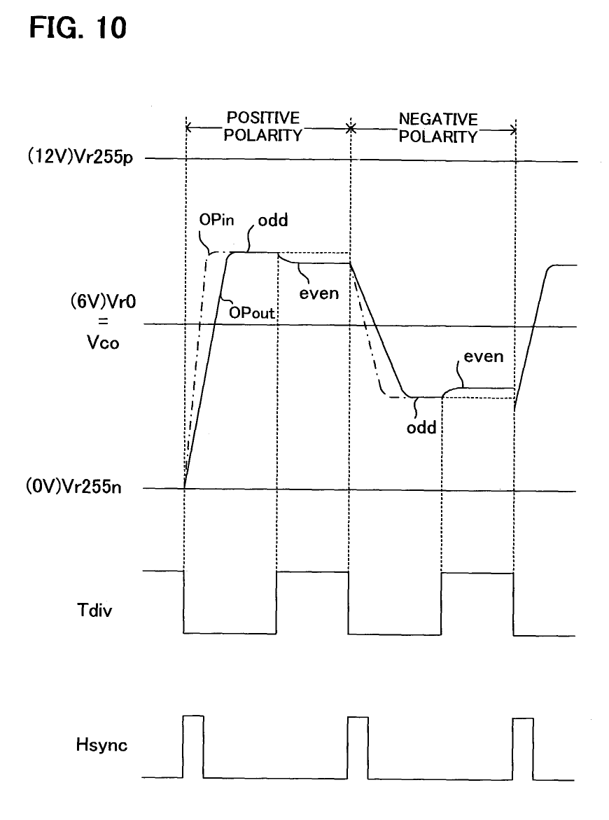

FIG. 10 shows another drive waveform. In this example, in the first half of the horizontal synchronization period an odd gray level reference voltage is selected, and, in the latter half, an even gray level reference voltage is selected. Consequently, the constitution of the time division control circuits 40, 42 in FIGS. 5 and 7 and the gray level reference voltage supply transistors may also be afforded reverse polarities.

As shown in FIG. 10, the selector output, which is supplied to the operational amplifier input OPin, and the operational amplifier output OPout are driven in the first half at a higher odd gray level reference voltage, and, thereafter, when display data are of an even number, are shifted to an even gray level reference voltage. The waveform at the time of the transition from the first half to the latter half of the waveform is therefore the reverse of the example in FIG. 9.

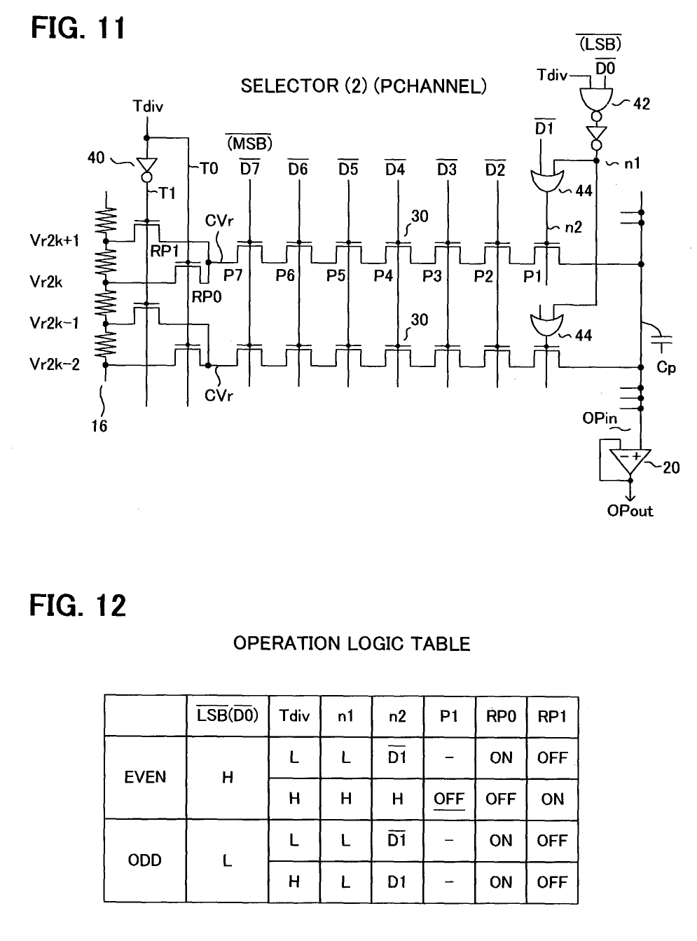

FIG. 11 is a detail circuit diagram of a selector, according to a second embodiment, and FIG. 12 is an operation logic table for same. The circuit in FIG. 11 is a positive polarity side circuit and is constituted from P-channel transistors. In the circuit in FIG. 5, the select transistor arrays 30 are each constituted from eight transistors. Meanwhile, in the second embodiment, the select transistor arrays 30 are each constituted from seven transistors P1 to P7, and a control signal n2, which is for the drive control transistor P1 of the seven transistors, is generated by an OR gate 44 to which the output signal n1 of the time division control circuit 42 and inverted data of a higher order bit D1 that follows the display data least significant bit are inputted. On the other hand, the time division control circuit 40 and the gray level reference voltage supply transistors RP0 and RP1 are the same as in the example in FIG. 5.

The operation in FIG. 11 will now be described, referring to the operation logic table in FIG. 12. The operation of the time division control circuit 42 is the same as for FIGS. 5 and 6. Therefore, with respect to select a transistor array 30 for which supplied display data /D1 to /D7 are all of an L level, in a first half in which the time division control signal Tdiv is at an L level, the node n1 is at an L level, meaning that the output of the OR gate 44, that is display data /D1 as is, is supplied to the transistor P1. In other words, the operation of the drive control transistor P1 is dependent on the display data /D1. Therefore, when all of the transistors of the select transistor array 30 for which the display data /D1 to /D7 are all of an L level are conductive, the even gray level reference voltage Vr2k or Vr2K−2 is outputted.

Further, in the latter half in which the time division control signal Tdiv is at an H level, when the display data are of an even number, the node n1 compulsorily assumes an H level, the node n2 also compulsorily assumes an H level, and the drive control transistor P1 compulsorily becomes non-conductive, such that the input OPin and output OPout of the operational amplifier are both maintained at the even gray level reference voltage Vr2k or Vr2K−2. In the latter half, when the display data are of an odd number, the node n1 remains at an L level, such that display data /D1 is supplied to the next node n2 as is. That is, the conductive state of the selected select transistor array 30 is maintained, where by an odd gray level reference voltage Vr2k+1 or Vr2K−1 is outputted. As a result, the input OPin and output OPout of the operational amplifier are changed to an odd gray level reference voltage.

Consequently, with respect also to the circuit in FIG. 11, the corresponding drive waveform is the same as the positive polarity waveform in FIG. 9. The quantity of transistors in the select transistor arrays 30 in the circuit example in FIG. 11 can be reduced by one. However, this is accompanied by a need to provide each of the select transistor arrays 30 with an OR gate 44 for the display bit /D1 that is one higher than the least significant bit D0.

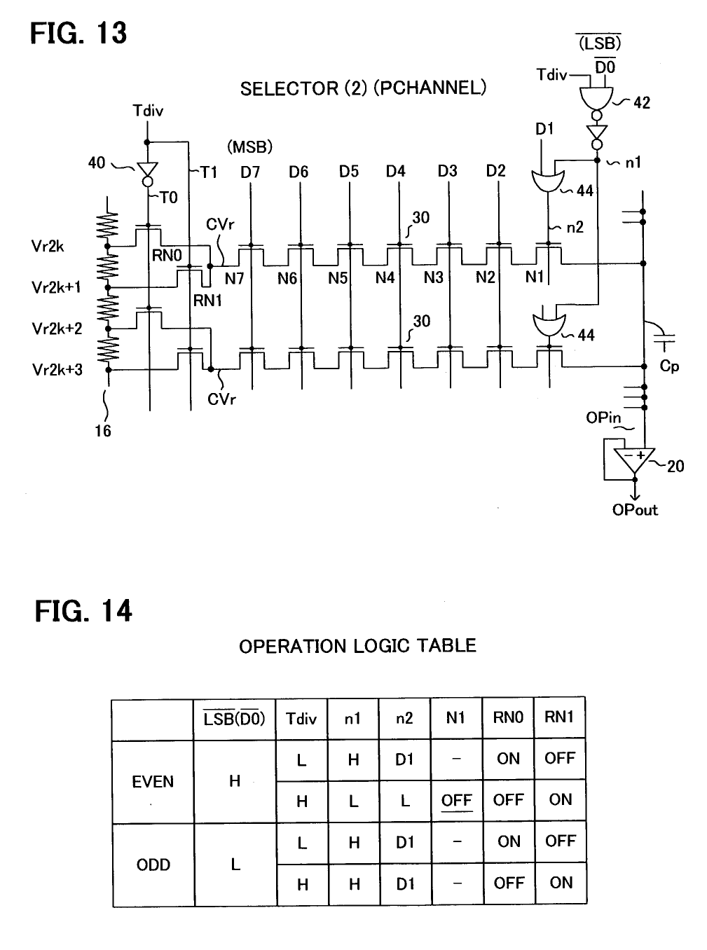

FIG. 13 is a selector detail circuit diagram for the negative polarity side thereof, according to the second embodiment, and FIG. 14 is an operation logic table for same. In this case, similarly, the select transistor arrays 30 are constituted from seven N-channel transistors N1 to N7. Accordingly, the higher order bit D1, which follows the least significant bit D0, is inputted along with the output n1 of the time division control circuit 42 to the AND gate 44, such that the output n2 thereof controls the drive control transistor N1.

The operation of the circuit in FIG. 13 is substantially the same as that for FIG. 11. When the operation of the circuit in FIG. 13 is described in accordance with FIG. 14, in the first half of the horizontal synchronization period, the output n1 of the time division control circuit 42 is an H level. As a result, the higher order bit D1 following the least significant bit is supplied to the drive control transistor N1 as is. Therefore, the select transistor array 30 for which all of the display data D1 to D7 are of an H level assumes a conductive state such that the even gray level reference voltage Vr2k or Vr2K+2 is outputted. Further, in the latter half of the horizontal synchronization period, when the display data are of an even number, the output n1 assumes an L level, such that the drive control transistor N1 is controlled so as to compulsorily become non-conductive. Thus, the output is maintained at the even gray level reference voltage Vr2k or Vr2K+2. Further, when display data are of an odd number, the output n1 assumes an H level, such that the display data D1 is applied to the transistor N1 as is. Consequently, a conductive state is maintained for the select transistor array 30 for which all the display data D1 to D7 are of an H level, such that the odd gray level reference voltage Vr2k+1 or Vr2K+3 is outputted.

Further, in the select transistor arrays 30 of FIGS. 11 and 13, the gate 44 could also be disposed in the position of any one of the display data D1 to D7. In other words, any of the transistors can also constitute a drive control transistor.

Also in the select transistor arrays 30 of FIGS. 11 and 13, a select drive operation is carried out with respect to even display data in the first half of the horizontal synchronization period, and, in the latter half thereof, a select drive operation is carried out with respect to odd display data.

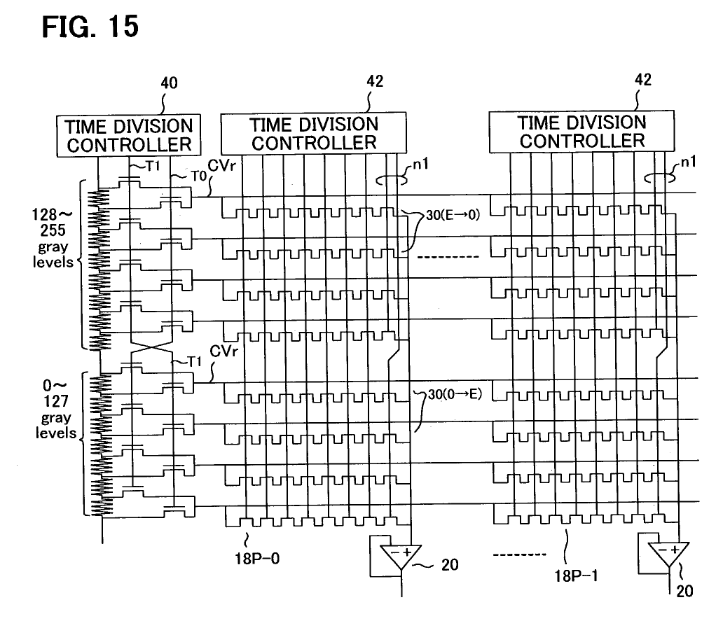

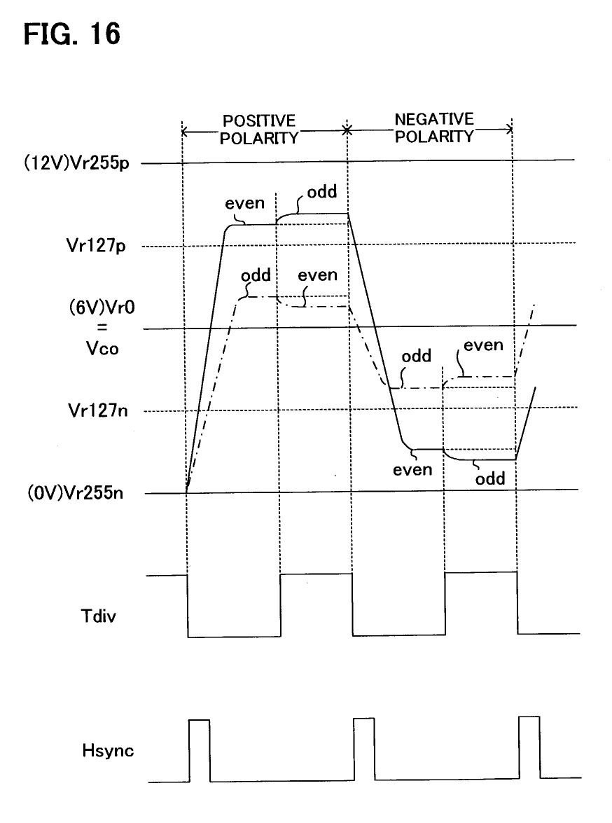

FIG. 15 is a circuit diagram of a selector according to a third embodiment, and FIG. 16 shows a drive waveform corresponding to the operation of same. In the first half of the horizontal synchronization period, the selector shown in FIG. 4 operates so as to drive the outputs of all of the select transistor arrays at even gray level reference voltages, and, in the latter half of the horizontal synchronization period, operates so as to drive the outputs of all of the select transistor arrays at odd gray level reference voltages. In the example of FIG. 15, the select transistor arrays are divided into two groups formed by: a first group 30 (E-O), the output thereof being driven at even gray level reference voltages in the first half of the horizontal synchronization period, and being driven at odd gray level reference voltages in the latter half; and a second group 30 (O-E), the output thereof being driven at odd gray level reference voltages in the first half of the horizontal synchronization period, and being driven at even gray level reference voltages in the latter half.

Moreover, the first group 30 (E-O) is provided on a high gray level reference voltage side, and the second group 30 (O-E) is provided on a low gray level reference voltage side.

Accordingly, the time division control signals T0, T1, which are outputted from the time division control circuit 40 are reversed with respect to the first and second groups. As a result, on the high gray level reference voltage side, even gray level reference voltages are supplied in the first half drive period to the common reference voltage lines CVr, and odd gray level reference voltages are supplied in the latter half drive period. Furthermore, a control signal n1, whose polarity is mutually opposite in the first and second groups, is supplied to the drive control transistor that corresponds to the least significant bit of the select transistor arrays 30 respectively.

The constitution of the negative polarity side selector transistor groups is the same as that in FIG. 15, and has therefore been omitted.

The constitution of the circuit in FIG. 15 becomes clearer through reference to the drive waveform of FIG. 16. The drive waveform indicated by the solid line in the figure corresponds to the select transistor arrays of the first group, and the drive waveform indicated by the alternate long and short dash line corresponds to the select transistor arrays of the second group. Irrespective of whether the polarity is a positive polarity or a negative polarity, when display data indicates a high gray level, the select transistor arrays 30 of the first group (E-O) are conductive, such that the selector output is driven at even gray level reference voltages in the first half drive period, and driven at odd gray level reference voltages in the latter half drive period. Further, when display data indicates a low gray level, the select transistor arrays 30 of the second group (O-E) are conductive, such that the selector output is driven at odd gray level reference voltages in the first half drive period, and driven at even gray level reference voltages in the latter half drive period.

In the third embodiment described above, the common reference voltage lines CVr of the high gray level side are at even gray level reference voltages in the first half, and odd gray level reference voltages in the latter half, and the common reference voltage lines CVr of the low gray level side are at voltages that are the inverse of those of the high gray level side. Therefore, of a plurality of common reference voltage lines that extend in a horizontal direction in the selector 18, whereas half of these common reference voltage lines are temporarily at a low gray level reference voltage and then at a high gray level reference voltage, the other half are temporarily at a high gray level reference voltage and then at a low gray level reference voltage. Hence, since a charging operation and a discharging operation for a wiring capacitance accompanying voltage fluctuations in the common reference voltage co-exist, it is possible to cancel noise which accompanies such a charging operation and discharging operation.

In this case, it is preferable that the gray level reference voltage on the higher gray level side is designed to rise from the first half to the latter half, so that the time for rising the output voltage of the selector can be shortened.

Further, if the object is only to cancel noise caused by the charging and discharging of the common reference voltage lines, the first group select transistor arrays and the second group select transistor arrays need not be divided into a high gray level side and a low gray level side. Even if first and second groups are allocated to optional combinations of gray level reference voltages, when the switch is made from the first half of the horizontal synchronization period to the latter half thereof, it is possible to charge half of the common reference voltage lines and discharge half of the common reference voltage lines simultaneously.

As detailed above, in the present embodiment, the select transistor arrays are provided with drive control transistors, which set the select transistor arrays to a drive enabled state in a first drive period, and, in a second drive period, set the select transistor arrays to a drive disabled state depending on whether display data are of an odd or even number. Further, adjacent gray level reference voltages are supplied to the common reference voltage lines CVr by means of time division. Also, select transistor arrays selected by the display data output one gray level reference voltage to the output terminal in the first drive period, and, in the second drive period, output another gray level reference voltage to the output terminal in accordance with display data. Thus, by performing control of the select transistor arrays by means of time division such that same assume a drive enabled state or drive disabled state, the quantity of select transistor arrays can be halved.

By means of the invention hereinabove, the quantity of transistors in the selector circuit can be reduced.

What is claimed is:

1. A selector circuit for selecting and outputting, in accordance with N-bit input data, one gray level reference voltage from 2^{N} gray level reference voltages, comprising:
a gray level reference voltage generating section which generates said 2^{N} gray level reference voltages;
a plurality of select transistor arrays which are provided in parallel between terminals of said gray level reference voltages and an output terminal and each of which has a plurality of serially connected transistors that are drive-controlled in accordance with said input data, each of said select transistor arrays being commonly provided for a group of M (M is a plurality and M<2^{N}) gray level reference voltages among the 2^{N} gray level reference voltages; and
a time division control circuit which causes said select transistor arrays to assume a drive enabled state by means of time division in correspondence with said M gray level reference voltages.

2. The selector circuit as claimed in claim 1, further comprising:
a gray level reference voltage supply circuit which serially supplies, by means of time division, each gray level reference voltage of said group of M gray level reference voltages, to said select transistor array,
wherein said time division control circuit causes said gray level reference voltage supply circuit to serially supply a gray level reference voltage to be driven, among said group of M gray level reference voltages, to said select transistor array; and causes said select transistor arrays to assume a drive enabled state to thereby output the gray level reference voltage to be driven to said output terminal.

3. The selector circuit as claimed in claim 1, further comprising:
a voltage holding circuit for holding voltages supplied to said output terminal,
wherein said time division control circuit causes said select transistor arrays to assume a drive enabled state in correspondence with a gray level reference voltage which is selected in accordance with said input data from among said group of M gray level reference voltages, and then controls the select transistor arrays to be non-conductive and causes said voltage holding circuit to hold the selected gray level reference voltage.

4. The selector circuit as claimed in claim 3, further comprising:
an operational amplifier whose positive input terminal is provided with a voltage held by said voltage holding circuit, the output of the operational amplifier being fed back to the negative input terminal of same.

5. The selector circuit as claimed in claim 3, wherein said select transistor array is constituted by serially connecting a plurality of transistors, to the respective gate of which a partial input data signal of said N bit input data signal is supplied, and a drive control transistor, to the gate of which a drive control signal from said time division control circuit is supplied; and wherein, when said drive control transistor is in a conductive state, said select transistor array assumes a drive enabled state, and, when the drive control transistor is in a non-conductive state, said select transistor array assumes a drive disabled state.

6. The selector circuit as claimed in claim 5,
wherein said M gray level reference voltages include adjacent first and second gray level reference voltages, and
wherein, in a first drive period, said drive control signal causes said drive control transistor to assume a conductive state such that said first gray level reference voltage is outputted to the output terminal via a selected select transistor array, and,
in a second drive period, said drive control signal causes said drive control transistor to assume a conductive state in accordance with the least significant bit of said input data, such that said output terminal changes from said first gray level reference voltage to the second gray level reference voltage via said selected select transistor array.

7. The selector circuit as claimed in claim 3,
wherein said input data signal has first and second data input signals;
said select transistor array is constituted by serially connecting a plurality of transistors, to the respective gate of which said first data signal is supplied, and a drive control transistor, to the gate of which said second data signal is supplied in accordance with a drive control signal from said time division control circuit; and,
when said drive control transistor is in a conductive state, said select transistor array assumes a drive enabled state, and, when the drive control transistor is in a non-conductive state, said select transistor array assumes a drive disabled state.

8. The selector circuit as claimed in claim 7,
wherein said M gray level reference voltages include first and second adjacent gray level reference voltages, and
wherein, in a first drive period, said drive control signal supplies said second data signal to said drive control transistor, such that said first gray level reference voltage is outputted to the output terminal via a selected select transistor array, and,
in a second drive period, said drive control signal supplies said second data signal to said drive control transistor in accordance with the least significant bit of said input data, such that said output terminal changes from said first gray level reference voltage to the second gray level reference voltage via said selected select transistor array.

9. A selector circuit for selecting and outputting, in accordance with N-bit input data, one gray level reference voltage from 2^{N} gray level reference voltages, comprising:
a gray level reference voltage generating section which generates said 2^{N} gray level reference voltages;
a plurality of common reference voltage lines which, by means of time division, are serially supplied with M gray level reference voltages of said 2^{N} gray level reference voltages;
a plurality of select transistor arrays which are provided in parallel between said plurality of common reference voltage lines and an output terminal, and each of which has a plurality of serially connected transistors that are controlled in accordance with said input data;
a voltage holding circuit for holding voltages supplied to said output terminal; and
a time division control circuit which causes said select transistor arrays to assume a drive enabled state in correspondence with a gray level reference voltage which is selected, in accordance with said input data, from among said group of M gray level reference voltages, and then controls the select transistor arrays to be non-conductive and causes said voltage holding circuit to hold the selected gray level reference voltage.

10. The selector circuit as claimed in claim 9, further comprising:
a gray level reference voltage supply circuit for serially supplying, by means of time division, said M gray level reference voltages to said corresponding common reference voltage lines.

11. A selector circuit for selecting and outputting, in accordance with N-bit input data, one gray level reference voltage from 2^{N} gray level reference voltages, comprising:
a gray level reference voltage generating section which generates said 2^{N} gray level reference voltages;
a plurality of common reference voltage lines which, by means of time division, are serially supplied with adjacent first and second gray level reference voltages of said 2^{N} gray level reference voltages;
a plurality of select transistor arrays which are provided in parallel between said plurality of common reference voltage lines and an output terminal, and each of which has a plurality of serially connected transistors that are controlled in accordance with said input data;
a voltage holding circuit for holding voltages supplied to said output terminal; and
a time division control circuit which, in a first drive period, causes said plurality of select transistor arrays to assume a drive enabled state to thereby cause one of said first and second gray level reference voltages to be outputted to said output terminal via a select transistor array selected in accordance with said input data, and, in a second drive period following said first drive period, causes said plurality of select transistor arrays to assume a drive enabled state or a drive disabled state in accordance with a prescribed bit signal of said input data, and, during a drive enabled state, causes the other of the first and second gray level reference voltages to be outputted to said output terminal via said selected select transistor array.

12. The selector circuit as claimed in claim 11,
wherein said 2^{N} gray level reference voltages have first and second gray level reference voltage groups, and
wherein first gray level reference voltages are supplied in said first drive period and second gray level reference voltages are supplied in said second drive period to the common reference voltage lines corresponding to said first gray level reference voltage group, and second gray level reference voltages are supplied in said first drive period and first gray level reference voltages are supplied in said second drive period to the common reference voltage lines corresponding to said second gray level reference voltage group.

13. A liquid crystal display panel driver circuit, comprising:
a selector circuit for selecting and outputting, in accordance with N-bit input data, one gray level reference voltage from 2^{N} gray level reference voltages, said selector circuit including:
a gray level reference voltage generating section which generates said 2^{N} gray level reference voltages;
a plurality of select transistor arrays which are provided in parallel between terminals of said gray level reference voltages and an output terminal and each of which has a plurality of serially connected transistors that are drive-controlled in accordance with said input data, each of said select transistor arrays being commonly provided for a group of M (M is a plurality and M<2^{N}) gray level reference voltages among the 2^{N} gray level reference voltages; and
a time division control circuit which causes said select transistor arrays to assume a drive enabled state by means of time division in correspondence with said M gray level reference voltages.

14. A liquid crystal display panel driver circuit, comprising:
a selector circuit for selecting and outputting, in accordance with N-bit input data, one gray level reference voltage from 2^{N} gray level reference voltages, said selector circuit including:
a gray level reference voltage generating section which generates said 2^{N} gray level reference voltages;
a plurality of common reference voltage lines which, by means of time division, are serially supplied with M gray level reference voltages of said 2^{N} gray level reference voltages;
a plurality of select transistor arrays which are provided in parallel between said plurality of common reference voltage lines and an output terminal, and each of which has a plurality of serially connected transistors that are controlled in accordance with said input data;
a voltage holding circuit for holding voltages supplied to said output terminal; and
a time division control circuit which causes said select transistor arrays to assume a drive enabled state in correspondence with a gray level reference voltage which is selected, in accordance with said input data, from among said group of M gray level reference voltages, and then controls the select transistor arrays to be non-conductive and causes said voltage holding circuit to hold the selected gray level reference voltage.

15. A liquid crystal display panel driver circuit, comprising:
a selector circuit for selecting and outputting, in accordance with N-bit input data, one gray level reference voltage from 2^{N} gray level reference voltages, comprising:
a gray level reference voltage generating section which generates said 2^{N} gray level reference voltages;
a plurality of common reference voltage lines which, by means of time division, are serially supplied with adjacent first and second gray level reference voltages of said 2^{N} gray level reference voltages;
a plurality of select transistor arrays which are provided in parallel between said plurality of common reference voltage lines and an output terminal, and each of which has a plurality of serially connected transistors that are controlled in accordance with said input data;
a voltage holding circuit for holding voltages supplied to said output terminal; and
a time division control circuit which, in a first drive period, causes said plurality of select transistor arrays to assume a drive enabled state to thereby cause one of said first and second gray level reference voltages to be outputted to said output terminal via a select transistor array selected in accordance with said input data, and, in a second drive period following said first drive period, causes said plurality of select transistor arrays to assume a drive enabled state or a drive disabled state in accordance with a prescribed bit signal of said input data, and, during a drive enabled state, causes the other of the first and second gray level reference voltages to be outputted to said output terminal via said selected select transistor array.
